(19) United States
(12) Patent Application Publication
(10) Pub. No.: US 2011/0241410 A1
(43) Pub. Date: Oct. 6, 2011

(54) Carriagage wheel assembly

(76) Inventor: Fu-Hsing Tan, Lu Chu (TW)

(21) Appl. No.: 12/010,661

(22) Filed: Jan. 28, 2008

(51) Int. Cl. B62D 55/08; B62D 55/30; B60B 19/12; B62D 55/14; B62D 55/24

(52) U.S. Cl. 301/5.1; 305/124; 305/126

(57) ABSTRACT

A carriage wheel assembly for golf bag drag carriage or baby carriage is disclosed to include a wheel holder assembly, two road wheels respectively mounted on front and rear wheel axles at the wheel holder assembly, multiple auxiliary wheels respectively mounted on a respective wheel axle between the road wheels, and a capillary track supported on the road wheels and the auxiliary wheel and surrounding the wheel holder assembly for direct contact with the ground.

### BACKGROUND OF THE INVENTION

1. Field of the Invention

The present invention relates to wheels and more particularly, to a carriage wheel assembly for golf bag drag carriage, baby carriage or wheeled chair, which has a broad surface contact area. And which facilitates storage of the carriage or wheeled chair.

2. Description of the Related Art

Conventional golf bag drag carriages, baby carriages and wheeled chair commonly have a frame structure provided with 2 or 4 wheels convenient for movement on the floor or ground. The frame structure of a golf bag drag carriage is directly affixed to the body of a golf bag so that the user can carry the golf bag with a full set of golf clubs and the related accessories in a golf course conveniently with less effort.

The wheels of a conventional golf bag drag carriage are round wheels. When moving a conventional golf bag drag carriage on a green lawn in a golf course, the running wheels of the golf bag drag carriage may damage the green lawn. Further, when a golf bag drag carriage is collapsed, the wheels are still kept protruding over one side of the carriage frame, and much storage is necessary for keeping the collapsed golf bag drag carriage.

### SUMMARY OF THE INVENTION

The present invention has been accomplished under the circumstances in view. It is one object of the present invention to provide a carriage wheel assembly, which, when used in a golf bag drag carriage and moving with the golf bag drag carriage, does not damage the green lawn It is another object of the present invention to provide a carriage wheel assembly, which maintains stability of the carriage when moving on an uneven or sloping road surface, or over steps. It is still another object of the present invention to provide a carriage wheel assembly, which occupies less storage space when collapsed with the carriage.

To achieve these and other objects of the present invention, the a wheel holder assembly, the wheel holder assembly comprising two first wheel axles respectively located at a front side and a rear side and at least one second wheel axle spaced between the first wheel axles; two road wheels respectively mounted on the first wheel axles; at least one auxiliary wheel respectively mounted on the at least one second wheel axle between the road wheels, each the auxiliary wheel having a diameter smaller than the road wheels; and a capillary track supported on the road wheels and the at least one auxiliary wheel and surrounding the wheel holder assembly for direct contact with the ground.

### BRIEF DESCRIPTION OF THE DRAWINGS

FIG. 1 is an elevational view of a carriage wheel assembly in accordance with a first embodiment of the present invention.

FIG. 2 is an exploded view of the carriage wheel assembly in accordance with the first embodiment of the present invention.

FIG. 3 is a side plain view of the carriage wheel assembly in accordance with the first embodiment of the present invention.

FIG. 4 is a side plain view of the carriage wheel assembly in accordance with a second embodiment of the present invention.

FIG. 5 is a side plain view of the carriage wheel assembly in accordance with a third embodiment of the present invention.

FIG. 6 is a schematic drawing showing the carriage wheel assembly of the first embodiment of the present invention used in a golf bag drag carriage.

FIG. 7 corresponds to FIG. 6, showing the golf bag drag carriage received.

FIG. 8 is a schematic drawing showing the carriage wheel assembly of the first embodiment of the present invention used in a baby carriage.

FIG. 9 is a schematic sectional plain view of a carriage wheel assembly in accordance with a fourth embodiment of the present invention.

FIG. 10 is an oblique elevation of a carriage wheel assembly in accordance with a fifth embodiment of the present invention.

FIG. 11 is a side plain view of the carriage wheel assembly in accordance with the fifth embodiment of the present invention.

FIG. 12 is an exploded view of the carriage wheel assembly in accordance with the fifth embodiment of the present invention.

FIG. 13 is an exploded view of the carriage wheel assembly in accordance with the sixth embodiment of the present invention.

### DETAILED DESCRIPTION OF THE PREFERRED EMBODIMENT

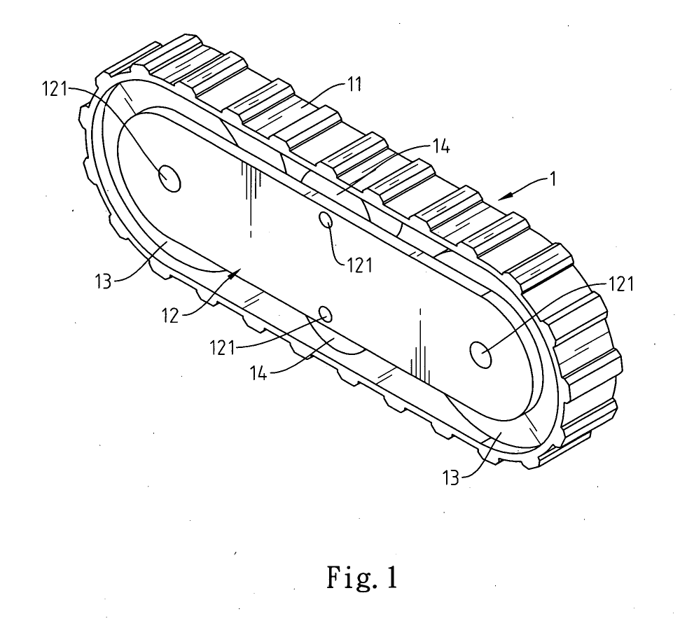

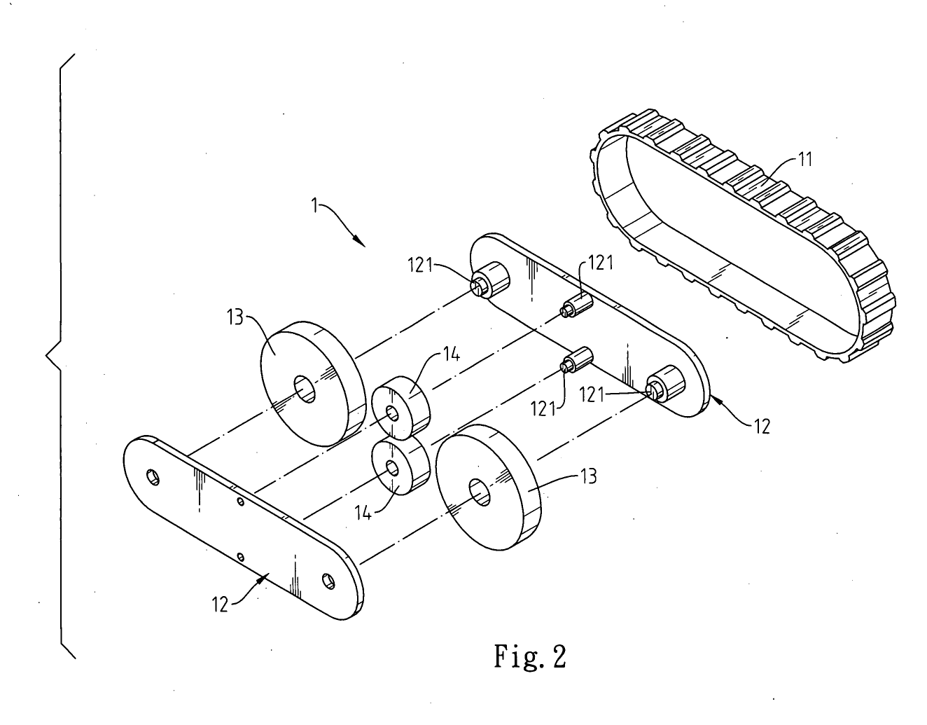

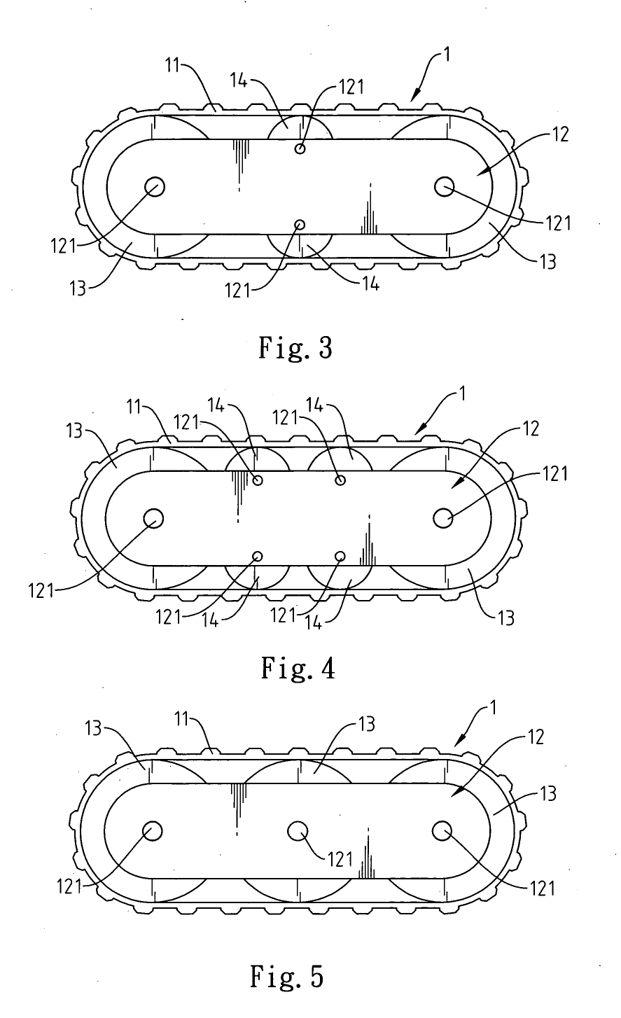

Referring to FIGS. 1˜3, a carriage wheel assembly 1 in accordance with the present invention is shown comprising a capillary track 11, a wheel holder assembly 12, two road wheels 13, and two auxiliary wheels 14. The wheel holder assembly 12 comprises a plurality of wheel axles 121. The road wheels 13 have a diameter greater than the auxiliary wheels 14. The road wheels 13 and the auxiliary wheels 14 are respectively mounted on the wheel axles 121 such that the two road wheels 13 are horizontally disposed at two opposite lateral sides, and the two auxiliary wheels 14 are arranged on the middle between the two road wheels 13 and vertically disposed in contact with each other. The capillary track 11 surrounds the wheel holder assembly 12, and is supported on the road wheels 13 and the auxiliary wheels 14.

FIG. 4 is a side plain view of the carriage wheel assembly in accordance with a second embodiment of the present invention. This embodiment is substantially similar to the aforesaid first embodiment with the exception that this second embodiment has two sets of auxiliary wheels 14 arranged on the middle between the two road wheels 13.

FIG. 5 is a side plain view of the carriage wheel assembly in accordance with a third embodiment of the present invention. According to this embodiment, the carriage wheel assembly comprise a wheel holder assembly 12 having a plurality of wheel axles 121 horizontally arranged in line, and a plurality of road wheels 13, respectively mounted on the wheel axles 121 of the wheel holder assembly 12, and a capillary track 11 surrounding the wheel holder assembly 12 and supported on the road wheels 13.

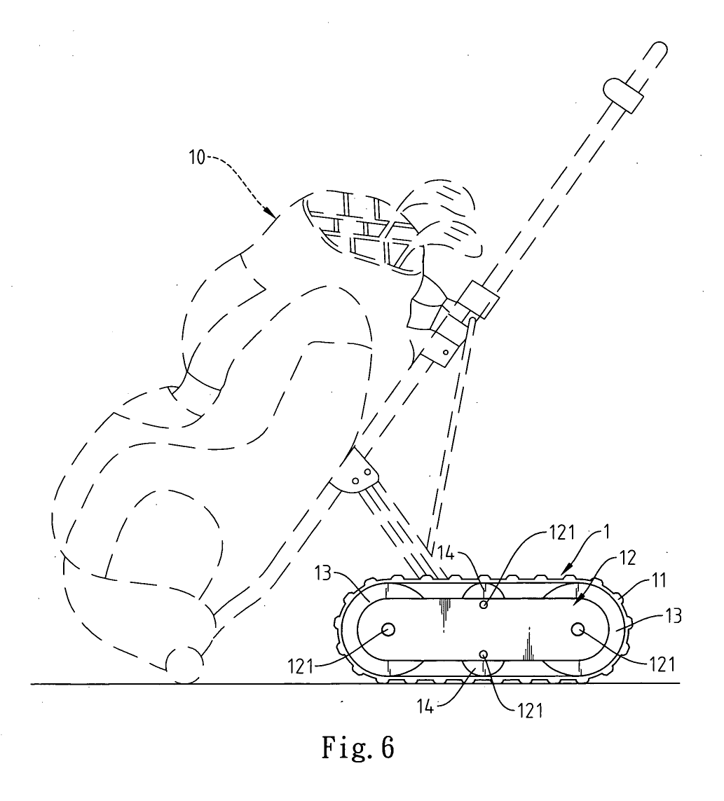

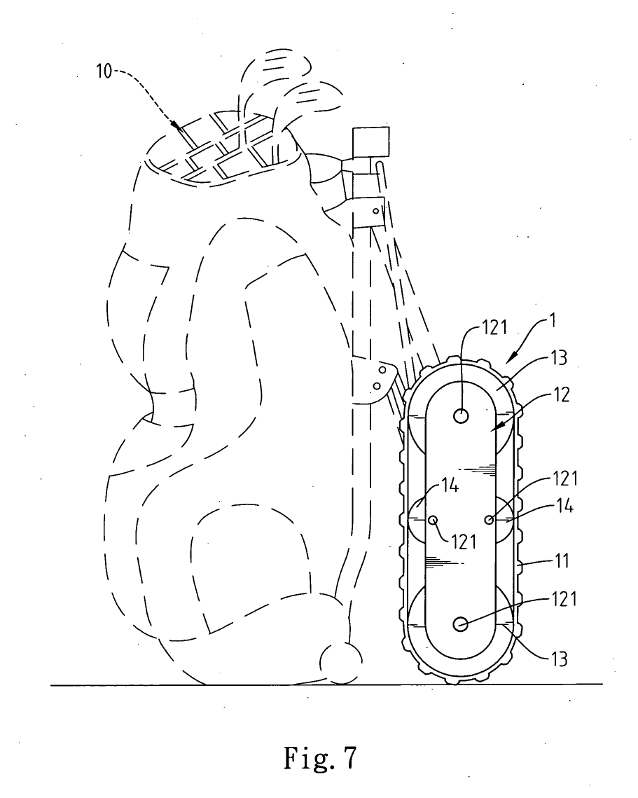

Referring to FIGS. 6 and 7, the carriage wheel assembly 1 is shown used in a golf bag drag carriage 10. When the carriage wheel assembly 1 is received with the golf bag drag carriage 10, the extending direction of the carriage wheel assembly 1 is kept in parallel to the extending direction of the collapsed golf bag drag carriage 10 (see FIG. 7), saving much storage space.

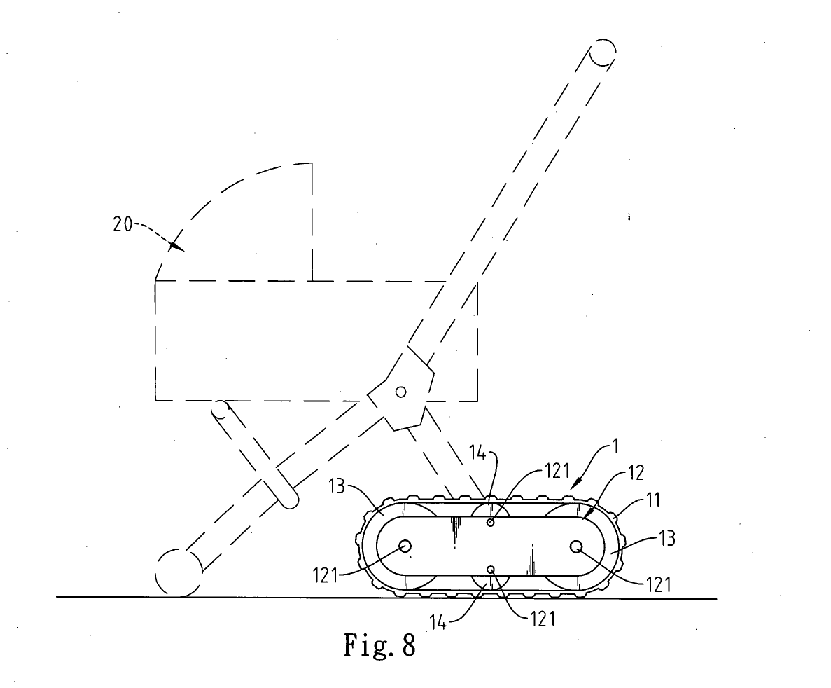

Referring to FIG. 8, the carriage wheel assembly 1 is practical for use in a baby carriage 20. When the baby carriage 20 is collapsed, the extending direction of the carriage wheel assembly 1 is kept in parallel to the extending direction of the collapsed baby carriage 20, saving much storage space.

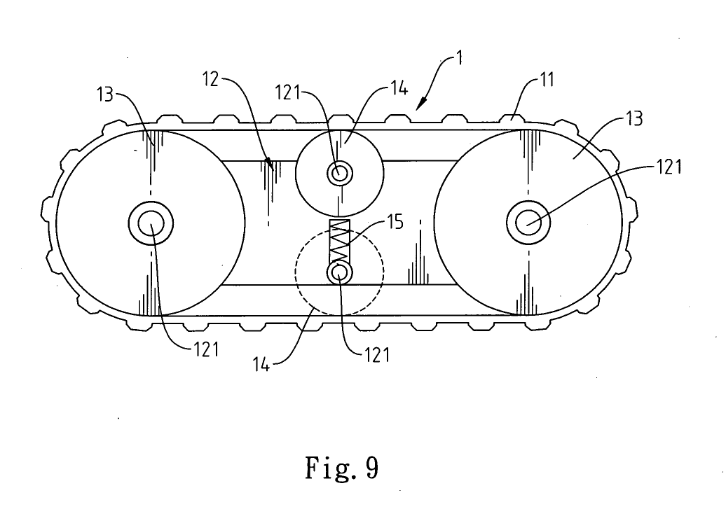

FIG. 9 is a schematic sectional plain view of a carriage wheel assembly 1 in accordance with a fourth embodiment of the present invention. This embodiment is substantially similar to the aforesaid first embodiment with the exception that a spring member 15 is provided at the wheel holder assembly 12 to support the bottom-sided auxiliary wheels 14 that is radially movably supported on the respective wheel axle 121 (for example, by means of a slip joint). When the carriage wheel assembly 1 is moving over an uneven road surface, the spring member 15 absorbs shocks.

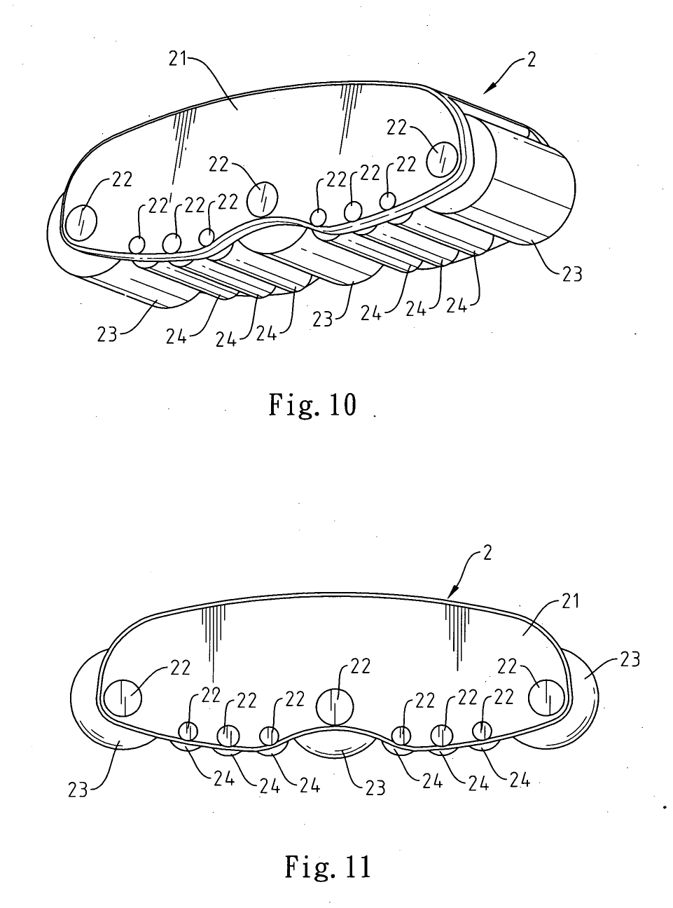

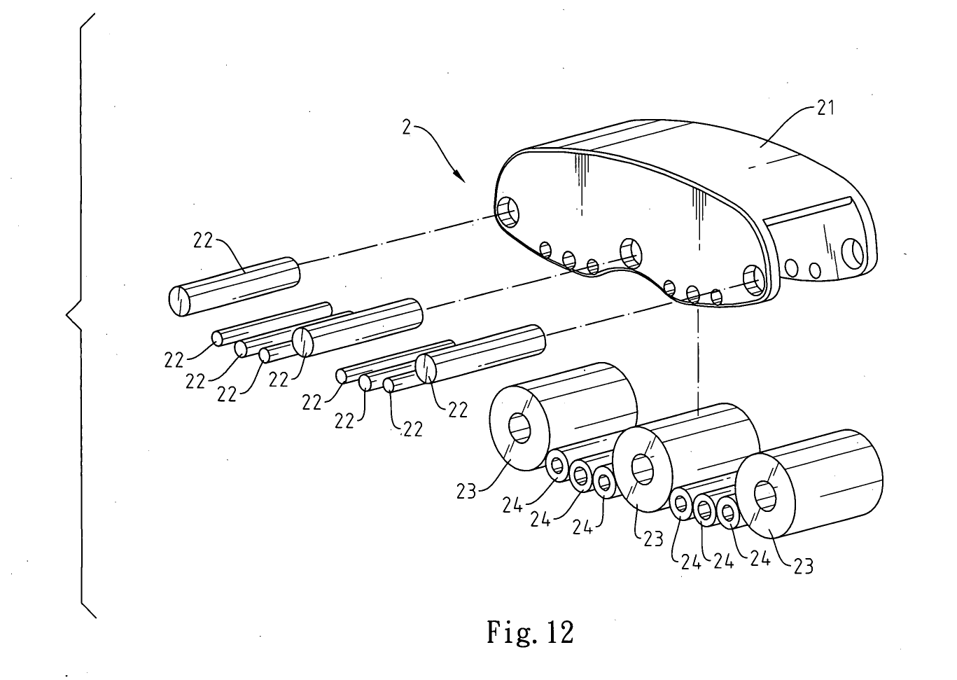

FIGS. 10˜12 show a carriage wheel assembly 2 in accordance with a fifth embodiment of the present invention. According to this embodiment, the carriage wheel assembly 2 comprises a wheel holder 21, a plurality of wheel axles 22 transversely mounted inside the wheel holder 2, and a plurality of road wheels 23 and auxiliary wheels 24 respectively mounted on the wheel axles 22. According to this embodiment, there are three road wheels 23 respectively located at front and rear sides and a middle part of the wheel holder 2 and peripherally protruding over the bottom side of the wheel holder 21 for direct contact with the road surface. Further, the auxiliary wheels 24 are arranged between each two adjacent road wheels 23 and peripherally protruding over the bottom side of the wheel holder 21 for direct contact with the road surface.

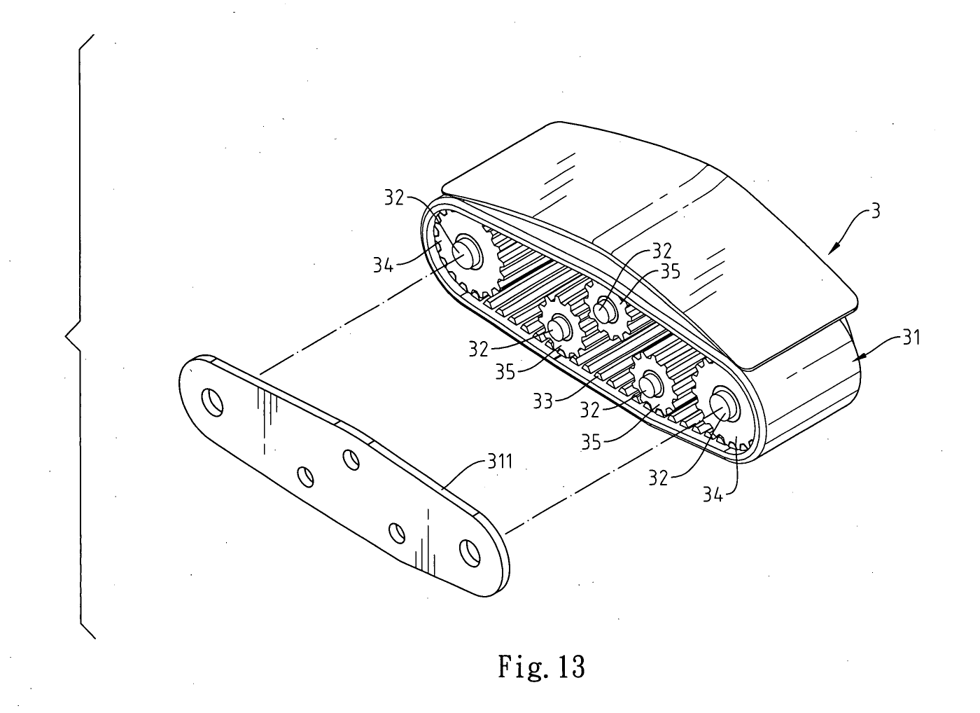

FIG. 13 shows a carriage wheel assembly 3 in accordance with a sixth embodiment of the present invention. According to this embodiment, the carriage wheel assembly 3 comprises a wheel holder 31, a side cover 311 covering one side of the wheel holder 31, a plurality of wheel axles 32 provided inside the wheel holder 31 and connected between the wheel holder 31 and the cover 311, two road wheels 24 and a plurality of auxiliary wheels 35 respectively mounted on the wheel axles 32 in such a manner that the road wheels 24 are located at two sides and the auxiliary wheels 35 are located between the road wheels 24, and a capillary track 33 supported on the road wheels 24 and the auxiliary wheels 35 and peripherally protruding over the bottom side of the assembly of the wheel holder 31 and the side cover 311 for direct contact with the road surface. According to this embodiment, the road wheels 24 and the auxiliary wheels 35 are toothed wheels, and the capillary track 33 is an internally toothed track meshed with the teeth of the road wheels 24 and the auxiliary wheels 35. Further, the auxiliary wheels 35 are adapted to adjust the tension of the capillary track 33.

Although particular embodiments of the invention have been described in detail for purposes of illustration, various modifications and enhancements may be made without departing from the spirit and scope of the invention.

What the invention claimed is:

1. A carriage wheel assembly comprising:
a wheel holder assembly, said wheel holder assembly comprising two first wheel axles respectively located at a front side and a rear side and at least one second wheel axle spaced between said first wheel axles;
two road wheels respectively mounted on said first wheel axles;
at least one auxiliary wheel respectively mounted on said at least one second wheel axle between said road wheels, each said auxiliary wheel having a diameter smaller than said road wheels; and
a capillary track supported on said road wheels and said at least one auxiliary wheel and surrounding said wheel holder assembly for direct contact with the ground.

2. The carriage wheel assembly as claimed in claim 1, wherein each said auxiliary wheel is radially movably supported on the associating wheel axle.

3. The carriage wheel assembly as claimed in claim 1, wherein each said auxiliary wheel is radially movably supported on the associating wheel axle, and a spring member is provided at said wheel holder assembly to support each said auxiliary wheels on the associating wheel axle.

4. A carriage wheel assembly comprising:
a wheel holder, said wheel holder having a bottom open side;
a plurality of first wheel axles horizontally mounted inside said wheel holder;
a plurality of second wheel axles horizontally mounted inside said wheel holder between each two adjacent first wheel axles;
a plurality of road wheels respectively mounted on said first wheel axles and peripherally protruding over the bottom open side of said wheel holder for direct contact with the ground; and
a plurality of auxiliary wheels respectively mounted on said second wheel axles and peripherally protruding over the bottom open side of said wheel holder for direct contact with the ground, said auxiliary wheels having a diameter smaller than said road wheels.

5. The carriage wheel assembly as claimed in claim 4, wherein multiple second wheel axles are arranged in parallel between each two adjacent first wheel axles to support one respective auxiliary wheel.

6. A carriage wheel assembly comprising:
a wheel holder, said wheel holder having a bottom open side;
two first wheel axles provided at front and rear sides of said wheel holder;
a plurality of second wheel axles horizontally provided at the same side of said wheel holder between said first wheel axles;
two toothed road wheels mounted on said first wheel axles;
an internally toothed capillary track supported on and meshed with said toothed road wheels and peripherally protruding over the bottom open side of said wheel holder; and
a plurality of toothed auxiliary wheels mounted on said second wheel axles between said road wheels within said internally toothed capillary track and meshed with said internally toothed capillary track for controlling the tension of said internally toothed capillary track.
